(19) United States
(12) Patent Application Publication
(10) Pub. No.: US 2026/0217204 A1
(43) Pub. Date: Jul. 30, 2026

(54) Holder for Vibration-Insulating Attachment of at least One Conduit in a Vehicle

(71) Applicant: Illinois Tool Works Inc., Glenview, IL (US)

(72) Inventors: Thomas Steimer, Saulheim (DE); Javier Arteta, Puente de la Reina (ES)

(21) Appl. No.: 19/439,133

(22) Filed: Jan. 2, 2026

(30) Foreign Application Priority Data
Jan. 24, 2025 (DE) 10 2025 102 647.5

(51) Int. Cl. B60R 16/02; B60H 1/00; B60T 17/04; H02G 3/32

(52) U.S. Cl. CPC B60R 16/0215; B60H 1/00571; H02G 3/32; B60T 17/046

(57) ABSTRACT

The disclosure relates to a holder (1) for vibration-insulating attachment of at least one conduit (100) in a vehicle. The holder (1) comprises a base region (2) and a receiving region (3) connected to the base region (2), which is associated with at least one receiving section (5) with a cross section wall shaped as a circle segment or U-shaped with a recess suitable for receiving the conduit (100) to be fastened. The receiving section (5) comprises an insertion region (6) facing away from the base region (2), via which the conduit (100) to be fastened can be inserted into the receiving section (5), wherein the receiving section (5) is connected to the receiving region (3) via at least one spring section (7) configured in such a manner that the receiving section (5) is movably supported relative to the receiving region (3) in the insertion direction of the conduit (100) to be fastened. To facilitate the insertion of the conduit (100) to be fastened in the receiving section (5), the holder (1) comprises an insertion aid associated with the receiving section (5), which comprises at least one lead-in chamfer connected to the receiving region (3), extending at least towards the insertion region (6) of the receiving section (5) and comprising a window or recess area (9). The lead-in chamfer is configured such that the at least one spring section (7) can move at least partially or in regions in the window or recess area (9) of the lead-in chamfer or through the window or recess area (9) of the lead-in chamfer.

### RELATED APPLICATIONS

The present application claims the benefit of German Patent Application No. 10 2025 102 647.5, filed Jan. 24, 2025, titled “Mount for Vibration-Isolating Fastening of at Least One Cable in a Vehicle,” the contents of which are hereby incorporated by reference.

### BACKGROUND

To route conduits, such as, for example, cables, in vehicles, holders are typically provided that fix or hold the conduits to the vehicle at regular intervals. Between such holders, the conduit may, under certain circumstances, vibrate freely, as a result of which the conduit may strike the vehicle body. This may lead to undesired noise generation or damage. However, reducing the spacing of the holders in order to prevent oscillation of the conduits is often not possible or not reasonable for cost reasons.

To reduce noise generation upon oscillation of such conduits, it is known to provide vibration dampers on the conduits between the conduit holders, which, on the one hand, bring about a change in the vibration behavior by increasing the mass of the conduit. On the other hand, these vibration dampers are manufactured from a soft material, as a result of which impact of the conduit against a rigid object, for example, against a vehicle body component, can be damped.

Such vibration dampers are typically manufactured from a two component plastic, having a receiving portion for the conduit formed from a hard plastic, in which the conduit can be securely retained. For damping, the receptacle is overmolded with a soft plastic that exhibits good damping behavior.

However, manufacture of such vibration dampers is relatively complex and cost intensive.

A similar problem exists in the fastening/assembly of hydraulic conduits, for example, brake conduits for brake systems, which are equipped, in particular, with an ABS system. In a response situation, the brake conduits are subjected to impulse-type loads depending on the braking situation. As a result, the brake conduits experience strong vibrations that may be transmitted to vehicle body components.

With the aim of decoupling these vibrations from the vehicle body components, it is generally known to manufacture a holder in a two-component injection-molding process, and to form the parts serving for fastening from a harder plastic than the part that forms the receiving section for the conduit. The receiving section is made of a relatively soft material and thus reduces the vibrations of the received conduit or largely avoids transmission to the vehicle body component.

As is also the case with the vibration dampers discussed above, the approach of manufacturing the holder by a two component injection molding process is disadvantageous, since plastic molded parts produced by a two component injection molding process are relatively complex.

### SUMMARY

The present disclosure relates generally to a holder, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and, in an isometric view, an exemplary embodiment of the holder according to the disclosure for vibration-isolating fastening of conduits in a vehicle.

FIG. 2 illustrates schematically, an isometric detail view of a receiving section of the exemplary embodiment of the holder according to the disclosure according to FIG. 1.

FIG. 3 illustrates schematically, a sectional view of the exemplary embodiment of the holder according to the disclosure according to FIG. 1.

FIG. 4 illustrates schematically, a detail of the sectional view of the exemplary embodiment of the holder according to the disclosure according to FIG. 3.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates, in general, to a fastening device for a conduit.

In particular, the disclosure relates to a holder for vibration-isolating fastening of at least one conduit in a vehicle. In particular, the conduit to be fastened is a pipeline, for example, a coolant conduit of a vehicle-internal air-conditioning system or, for example, a brake conduit of a brake system of the vehicle configured as a hydraulic conduit. However, the disclosure is not limited to such conduits to be fastened, but also comprises applications in which, for example, electrical conduits in a vehicle must be fastened in a vibration-isolating manner.

Accordingly, there is, in principle, a need for a holder for vibration-isolating fastening of a conduit in vehicles, in particular, on a vehicle body, wherein the holder must meet various requirements. On the one hand, the holder itself should provide sufficient holding force for conduits even at higher temperature ranges. On the other hand, the holder should enable vibration-isolating fastening of the conduit. Finally, the holder should be manufacturable as cost-effectively as possible and should enable simple assembly of the holder and/or of the conduit to be fastened by the holder.

In this context, a holder for vibration-isolating fastening of a conduit, in particular configured as a pipeline or an electrical conduit, in a vehicle is already known from document EP 3 263 966 B1. The holder known from this prior art is formed as a plastic part and comprises a base region and a receiving region formed in one piece with the base region. In this case, the receiving region comprises a plurality of receiving sections in which a conduit to be fastened is receivable in each case.

In order to achieve an isolating or damping effect against transmission of vibrations from the fastened conduit to the vehicle or vice versa, the holder known from EP 3 263 966 B1 provides that the receiving sections are configured to be movable relative to the base region, wherein corresponding window regions are provided in the base region, into which the receiving sections can move at least partially or in regions upon relative movement.

Even though the holder known from document EP 3 263 966 B1 does not exhibit the disadvantages that were previously discussed in connection with holders manufactured by a two component injection molding process, this holder is nevertheless not free of disadvantages.

In particular, in the holder known from EP 3 263 966 B1 for vibration-isolating fastening of the conduits, it is absolutely necessary that corresponding recess and/or window regions are formed in the base region of the holder. This weakens the base region in structural terms. This has the direct consequence that, in the assembly of the holder on the corresponding holding structure, for example, on the vehicle body, failure of the holder due to breakage of the base region may occur.

To avoid this, it would be necessary to configure the base region without window or recess regions, which, however, is only possible either if the vibration isolating property of the fastening is dispensed with, or if the corresponding receiving sections are arranged further away from the base region. However, the latter would have the disadvantage that the dimensions of the holder increase. In particular, in cases in which only a small installation space is available, for example, between the vehicle body and an interior trim part of the vehicle, such a holder is no longer usable.

Accordingly, the disclosure is based on the object, in particular, proceeding from the holder known from document EP 3 263 966 B1, of further developing said holder in such a manner that efficient vibration-isolating fastening of a conduit is possible with an at least substantially unchanged overall dimension of the holder, without structurally weakening the base region by corresponding window or recess regions.

The object underlying the disclosure is achieved, in particular, by the subject matter of independent claim 1, wherein advantageous developments of the holder according to the disclosure for vibration-isolating fastening of at least one conduit are specified in the corresponding dependent claims.

Accordingly, the disclosure relates in particular to a holder for vibration-isolating fastening of at least one conduit, preferably configured as a pipeline or an electrical conduit, in a vehicle.

Similarly to the holder known from EP 3 263 966 B1, the holder according to the disclosure comprises a base region. Via the base region of the holder, the holder is connectable to a holding structure of the vehicle, such as, for example, to a component of a vehicle body. To connect the holder to the holding structure via the base region, a bolt receiving opening is preferably formed in the base region. However, it is of course also conceivable that the holder is connected to the holding structure via its base region by means of another connection technique.

In contrast to the holder known from EP 3 263 966 B1, in the holder according to the disclosure the base region is preferably provided without window or recess regions. In this way, the base region is reinforced, and the risk of damage to the holder upon mounting of the holder on the retaining structure of the vehicle is at least lessened or reduced.

The holder according to the disclosure comprises, in addition to the base region, a receiving region. The receiving region is preferably formed integrally with the base region.

Preferably, a plurality of receiving sections are assigned to the receiving region of the holder according to the disclosure, each of which has an at least substantially identical structure. Each receiving section is formed by a wall that is at least substantially circular-segment-shaped in cross section or, as an alternative thereto, U-shaped, such that the receiving section forms a recess that is suitable for receiving a conduit to be fastened. The recess or the receiving section comprises an insertion region facing away from the base region of the holder, via which the conduit to be fastened is insertable into the corresponding receiving section and, in particular, into the recess of the receiving section and is, in particular, pluggable therein. In this case, the receiving section is preferably formed such that the conduit to be fastened is clipped into the receiving section.

The receiving section with the recess is, in a manner of speaking, mounted in a “floating” manner. For this purpose, the receiving section is connected to the receiving region of the holder via at least one spring section. In particular, the “floating” mounting of the receiving section via the at least one spring section is selected such that the receiving section with the recess is movable relative to the receiving region of the holder and relative to the base region of the holder in the insertion direction of the conduit to be fastened. In this way, vibration-isolating fastening of the conduit is achieved.

To simplify insertion of the conduit to be fastened into the receiving section or into the recess of the receiving section, the holder further comprises an insertion aid assigned to the receiving section. Such an insertion aid is advantageous, in particular, when the conduit to be fastened is clipped into the receiving section.

The insertion aid assigned to the receiving section comprises at least one insertion ramp connected to the receiving region of the holder. In this case, the insertion ramp extends at least in the direction of the insertion region of the recess.

According to the disclosure, in particular, it is provided that the insertion ramp is provided with a window or recess region. The window or recess region of the insertion ramp, on the one hand, and the spring section, on the other hand, are configured such that, at least upon a movement of the receiving section with the recess relative to the receiving region and relative to the base region of the holder in the insertion direction or counter to the insertion direction, the spring section may move at least partially or in regions into the window or recess region of the insertion ramp or may move through the window or recess region of the insertion ramp.

This construction has the decisive advantage that relative movement of the receiving section with respect to the receiving region and the base region of the holder is possible without having to increase the overall dimension of the holder, and additionally without having to provide corresponding window or recess regions in the base region of the holder, through which, as in the holder known from document EP 3 263 966 B1, the receiving section moves upon a movement of the receiving section relative to the receiving region of the holder.

In particular, the window or recess region of the insertion ramp is configured such that the insertion ramp is subdivided into a first region and a second region separated therefrom via the window or recess region.

In this case, it is particularly advantageous that, when viewed in the longitudinal extension direction of the receiving section, the distance between the first region of the insertion ramp and the second region of the insertion ramp separated therefrom via the window or recess region is greater than a width of the spring section, which is preferably formed as a wall section that is, in particular, strip shaped.

In particular, the first and second regions of the insertion ramp are preferably each configured as a strip-shaped or finger-shaped element having a first end region via which the strip-shaped or finger-shaped element is preferably integrally connected to the receiving region of the holder, and having an opposite second, free end region.

According to embodiments of the holder according to the disclosure, it is provided that the insertion ramp is elastically formed at least in the insertion direction, preferably in that, when viewed in cross section, the insertion ramp has a reduced wall thickness in the region via which the insertion ramp is preferably integrally connected to the receiving region of the holder.

In preferred embodiments of the holder according to the disclosure, it is provided that the insertion aid assigned to the receiving section comprises, on both sides of the insertion region, in each case at least one insertion ramp having a corresponding window or recess region.

In this case, it is preferably provided that, as seen in the cross section of the holder, a spacing between the free end regions of the insertion ramps provided on both sides of the insertion region is smaller than a spacing between the regions forming the insertion region of the receiving section of the wall that is, in cross section, at least substantially circular-segment-shaped or U-shaped.

According to embodiments of the holder according to the disclosure, it is provided that a free end region of the at least one insertion ramp does not extend into the insertion region of the recess.

As an alternative thereto, however, it is also conceivable that a free end region of the at least one insertion ramp extends at least into the insertion region of the recess and preferably furthermore serves as a hold-down for a conduit received in the recess of the receiving section.

In preferred embodiments of the holder according to the disclosure, it is provided that the at least one spring section is formed as a wall section that is in particular strip shaped, having a first end region via which the spring section is preferably integrally connected to the receiving region of the holder, and having an opposite second end region via which the spring section is preferably integrally connected to the receiving section.

According to developments of these embodiments of the holder according to the disclosure, as seen in the cross-sectional direction of the spring section, a wall thickness of the, in particular, strip-shaped wall section is at least in regions smaller than an, in particular, average wall thickness of the wall of the receiving section that is, in cross section, at least substantially circular-segment-shaped or U-shaped.

With regard to the spring section, it is preferred that, as seen in the cross-sectional direction of the spring section, the spring section has an at least partially or in regions curved shape and, in particular, an at least substantially S-shape.

Alternatively or additionally thereto, it is conceivable that the at least one receiving section formed by the wall that is, in cross section, at least substantially circular-segment-shaped or U-shaped is, on both sides of the insertion region, connected to the receiving region of the holder via at least one spring section, preferably integrally.

In particular, in the holder according to the disclosure, it is provided that a region in which the spring section is preferably connected integrally to the receiving region of the holder is arranged, offset in the direction of the base region of the holder, relative to a region in which the insertion ramp is preferably connected integrally to the receiving region of the holder.

According to embodiments of the holder according to the disclosure, it is provided that the receiving region comprises at least two wall regions extending away from the base region and preferably extending at least substantially parallel to one another, between which a receiving section formed by the wall that is, in cross section, at least substantially circular-segment-shaped or U-shaped is arranged at least partially or in regions.

In this context, it is conceivable that a first spring section is connected, on the one hand, to a first of the at least two wall regions of the receiving region and, on the other hand, to the receiving section, and that a second spring section is connected, on the one hand, to a second of the at least two wall regions of the receiving region and, on the other hand, to the receiving section, each preferably integrally.

Alternatively or additionally thereto, it is conceivable that a first insertion ramp of the insertion aid assigned to the receiving section is connected to a first of the at least two wall regions of the receiving region, and that a second insertion ramp of the insertion aid assigned to the receiving section is connected to a second of the at least two wall regions of the receiving region, each preferably integrally.

According to embodiments of the holder according to the disclosure, it is provided that the receiving region is assigned at least two and preferably three receiving sections arranged adjacent to one another such that, when the corresponding conduits to be fastened are introduced into the respective receiving sections, the respective insertion directions extend at least substantially parallel.

It is also conceivable that the receiving section comprises at least one reinforcing rib extending at least substantially in the longitudinal extension direction of the receiving section, preferably on an outer lateral surface of the wall that is, in cross section, at least substantially circular-segment-shaped or U-shaped.

The base region preferably comprises an at least substantially planar contact surface on the side facing away from the receiving region.

According to embodiments of the holder according to the disclosure, the holder comprises a sleeve-like shoulder that contains the bolt receiving opening, wherein at least a region of the sleeve-like shoulder extends into the receiving region of the holder.

The entire holder is preferably formed in one piece, in particular as a plastic injection molded part formed in one piece.

The exemplary embodiment of the holder 1 according to the disclosure shown in the drawings serves for vibration-isolating fastening of conduits 100 in a vehicle. In the case of the conduits 100, these are, for example, pipelines, in particular, fluid conduits of a vehicle-internal air-conditioning system, or hydraulic conduits of an ABS brake system. In principle, however, it is also conceivable that the conduits 100 are electrical conduits.

The exemplary embodiment of the holder 1 according to the disclosure shown in the drawings comprises a base region 2 via which the holder 1 may be fastened to a holding structure, for example, a body component of a vehicle.

For fastening the holder 1 to the holding structure, such as, for example, to a body component of the vehicle, a screw or a bolt is preferably used. For this purpose, it is advantageous that a corresponding bolt receiving opening 4 is formed in the base region 2.

However, it is of course also conceivable to connect the holder 1 to the holding structure of the vehicle via another fastening solution, for example, by adhesion.

Preferably, a receiving region 3 is provided, integrally formed in one piece with the base region 2 of the holder 1. The receiving region 3 of the holder 1 serves to hold preferably a plurality of receiving sections 5.

In the exemplary embodiment of the holder 1 according to the disclosure shown in the drawings, a total of three receiving sections 5 arranged adjacent to one another are used.

Each receiving section 5 is formed by a circular-segment-shaped wall such that a recess for receiving the conduit 100 to be fastened is formed. Preferably, the recess has, at least partially or in regions, a cross-sectional geometry complementary to the cross section of the conduit 100 to be received.

The receiving section 5 formed by the wall that is at least substantially circular segment shaped is configured such that the conduit 100 to be fastened can be clipped into the receiving section 5. For this purpose, the receiving section 5 or the recess comprises an insertion region 6 facing away from the base region 2.

For inserting or clipping the conduit 100 to be fastened, the receiving section 5 formed by the circular-segment-shaped wall is spread slightly such that the conduit 100 to be fastened may pass through the insertion region 6.

To hold the corresponding receiving sections 5, in the exemplary embodiment of the holder 1 according to the disclosure shown in the drawings it is provided that the receiving region 3 of the holder 1 comprises corresponding wall regions 10 extending away from the base region 2 and extending at least substantially parallel to one another. In the intermediate space between two adjacent wall regions 10 of the receiving region 3, a receiving section 5 is received in each case such that the circular-segment-shaped wall of the receiving section 5 is spaced both from the wall regions 10 of the receiving region 3 and from the lower surface of the base region 2.

The mechanical connection of the receiving sections 5 to the receiving region 3 of the holder 1, and, in particular, to the corresponding wall regions 10 of the receiving region 3, is achieved via two spring sections 7 arranged opposite one another. On the one hand, the spring sections 7 are connected in each case to an upper end region of the circular-segment-shaped wall of the receiving section 5 and, on the other hand, to a wall region 10 of the receiving region 3.

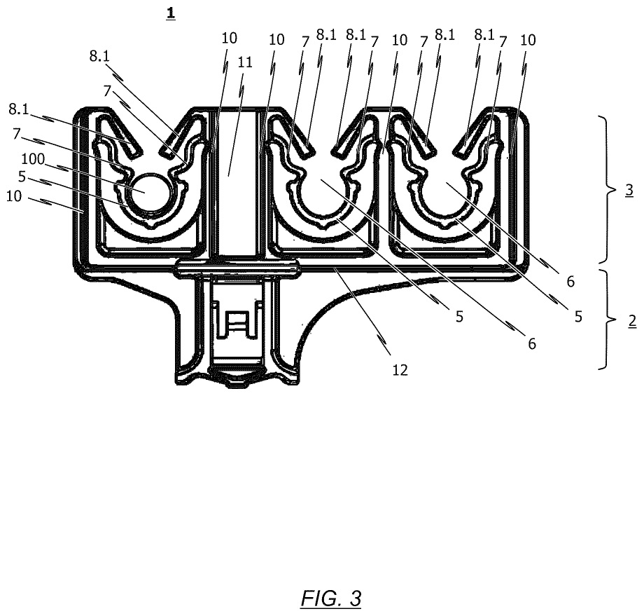

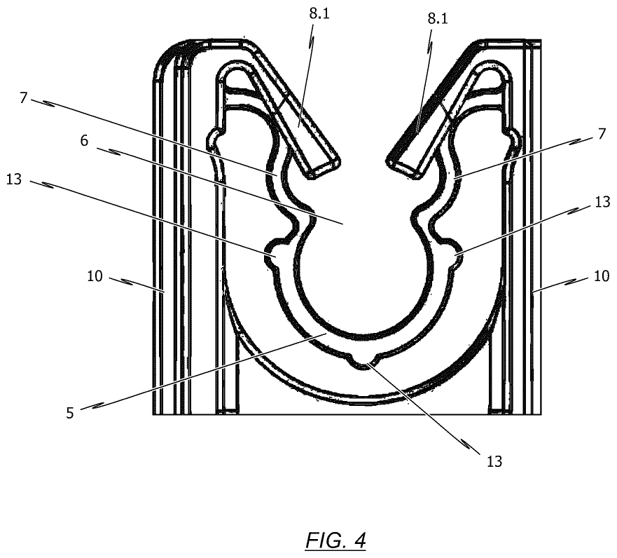

As can be seen, in particular, from the sectional views according to FIG. 3 and FIG. 4, each spring section 7 is configured, in particular, as a strip-shaped wall section with a first end region via which the spring section 7 is preferably integrally connected to the receiving region 3 or to a corresponding wall region 10 of the receiving region 3 of the holder 1, and with an opposite second end region via which the spring section 7 is likewise preferably integrally connected to the receiving section 5 or to the circular-segment-shaped wall of the receiving section 5.

It can furthermore be seen in the sectional views according to FIG. 3 and FIG. 4 that, when viewed in the cross section direction of the spring section 7, a wall thickness of the wall section that is, in particular, strip-shaped is, at least in regions, smaller than, in particular, a mean wall thickness of the wall of the receiving section 5 that is, in cross section, at least substantially circular-segment-shaped.

Furthermore, when viewed in the cross section direction of the spring section 7, the spring section 7 has a shape that is, at least partially or in regions, curved. In the exemplary embodiment of the holder 1 according to the disclosure shown in the drawings, in particular, an S-shape is used.

As a result, the spring section 7 is elastically configured. By means of the support of the receiving sections 5 provided via the corresponding spring sections 7, the receiving sections 5 are movable relative to the base region 2 of the holder 1.

To receive the conduit 100 to be fastened in a receiving section 5 of the holder 1, the conduit 100 must be inserted or clipped into the recess of the receiving section 5 via the insertion region 6 of the receiving section 5 facing away from the base region 2. In this case, the insertion region 6 is defined by the region between the upper end regions of the circular-segment-shaped wall that forms the receiving section 5.

To simplify the insertion of the conduit 100 to be fastened into the receiving section 5 or into the recess formed by the receiving section 5, a corresponding insertion aid assigned to the respective receiving section 5 is used. In this context, this comprises insertion ramps that extend at least in the direction of the insertion region 6 of the recess or of the receiving section 5.

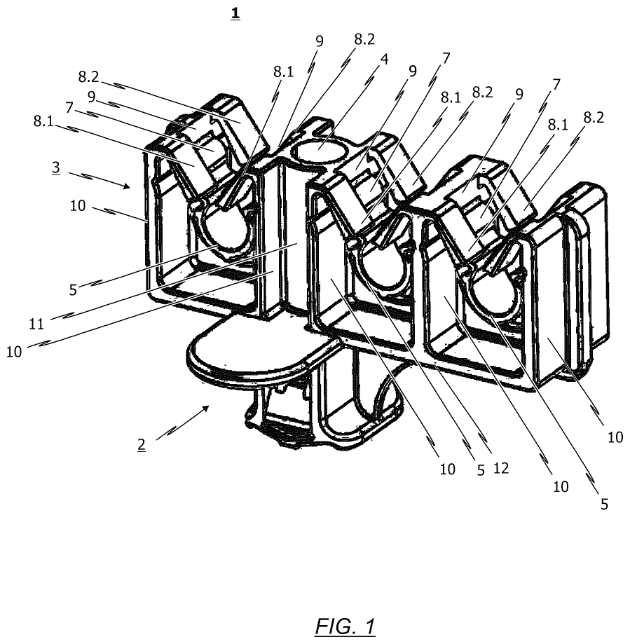

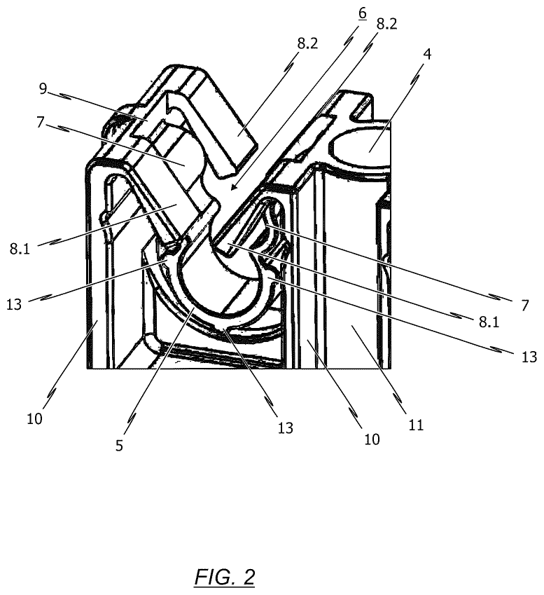

It can be seen from the isometric views according to FIG. 1 and FIG. 2 that each insertion ramp is provided with a corresponding window or recess region 9.

The window or recess region 9 of the insertion ramp is configured such that the insertion ramp is divided into a first region 8.1 and into a second region 8.2 that is separated therefrom via the window or recess region 9.

It can furthermore be seen from the isometric views according to FIG. 1 and FIG. 2 that, when viewed in the longitudinal extension direction of the receiving section 5, the distance between the first region 8.1 of the insertion ramp and the second region 8.2 of the insertion ramp that is separated therefrom via the window or recess region 9 is greater than a width of the spring section 7, which, in the exemplary embodiment of the holder 1 according to the disclosure shown in the drawings, is configured as a wall section that is, in particular, strip-shaped.

The exemplary embodiment of the holder 1 according to the disclosure is characterized, in particular, in that, by providing corresponding insertion ramps provided with a window or recess region 9, the spring section 7 may move, at least during a movement of the receiving section 5 relative to the receiving region 3 and relative to the base region 2 of the holder 1, at least partially or in regions into the window or recess region 9 of the insertion ramp or may move through the window or recess region 9 of the insertion ramp.

This enables a particularly compact structural design of the holder 1 according to the disclosure for vibration-isolating fastening of a conduit.

It can be seen from the sectional views in FIG. 3 and FIG. 4 that the respective regions 8.1 and 8.2 of the insertion ramp, which are formed by the respective window or recess region 9, are each preferably configured as a strip-shaped or finger-shaped element with a first end region via which the strip-shaped or finger-shaped element is preferably integrally connected to the receiving region 3 of the holder 1 and, in particular, to a wall region 10 of the receiving region 3 of the holder 1, and with an opposite second free end region.

In this case, the regions 8.1 and 8.2 of the insertion ramp are elastically formed in the insertion direction of the conduit 100 to be fastened.

It can be seen from the detailed view according to FIG. 4 in this context that the respective regions 8.1 and 8.2 of the insertion ramp, in the region via which the insertion ramp is preferably integrally connected to the receiving region 3 of the holder 1, have a reduced wall thickness.

It can furthermore be seen from the sectional view according to FIG. 4 that, when viewed in the cross section of the holder 1, a distance between the free end regions of the insertion ramps provided on both sides of the insertion region 6 is smaller than a distance between the regions forming the insertion region 6 of the receiving section 5 of the wall that is, in cross section, at least substantially circular segment shaped of the receiving section 5.

In the exemplary embodiment of the holder 1 according to the disclosure shown in the drawings, the free end regions of the insertion ramps do not extend into the insertion region 6 of the recess or of the receiving section 5.

However, it is in principle conceivable that the free end regions of the insertion ramps extend into the insertion region 6 of the recess or of the receiving section 5 such that the insertion ramps furthermore serve as a hold-down for a conduit 100 received in the recess of the corresponding receiving section 5.

To stiffen the receiving section 5 in a longitudinal extension direction of the receiving section 5 that is perpendicular to the insertion direction, the receiving section 5 is provided with reinforcing ribs 13 that extend in the longitudinal extension direction of the receiving section 5 and are preferably integrally formed on an outer circumferential surface of the wall of the receiving section 5 that is circular-segment-shaped in cross section.

It can be seen, in particular, from the illustration in FIG. 1 that the base region 2 comprises, on the side facing away from the receiving region 3, an at least substantially planar contact surface 12.

Finally, the sectional view according to FIG. 3 shows that the holder 1 comprises a sleeve-like shoulder 11 that contains the bolt receiving opening 4, wherein at least a region of the sleeve-like shoulder 11 extends into the receiving region 3 of the holder 1.

The entire holder 1 is formed in one piece, preferably as a plastic injection molded part formed in one piece.

The disclosure is not limited to the exemplary embodiment of the holder 1 according to the disclosure shown in the drawings, but results from a combination of all features disclosed herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

List of reference numerals

| | |
|---|---|
| 1 | holder |
| 2 | base region |
| 3 | receiving region |
| 4 | bolt receiving opening |
| 5 | receiving section |
| 6 | insertion region |
| 7 | spring section |
| 8.1 | first region of the insertion ramp |
| 8.2 | second region of the insertion ramp |
| 9 | window/recess region of the insertion ramp |
| 10 | wall region of the receiving region |
| 11 | sleeve-like shoulder |
| 12 | contact surface of the base region |
| 13 | reinforcing rib of the receiving section |
| 100 | conduit |

What is claimed is:

1. A holder (1) for vibration-insulating attachment of at least one conduit (100) preferably embodied as a pipeline or as an electrical cable (100) in a vehicle, wherein the holder (1) comprises the following:
a base region (2), in which a bolt receiving opening (4) is preferably formed; and
a receiving region (3) connected to the base region (2) and preferably formed integrally with the base region (2), which is associated with at least one receiving section (5) with a cross section wall shaped at least substantially as a circle segment or U-shaped with a recess suitable for receiving the conduit (100) to be fastened,
wherein the receiving section (5) comprises an insertion region (6) facing away from the base region (2), via which the conduit (100) to be fastened can be inserted into the receiving section (5) and in particular into the recess of the receiving section (5) and can preferably be clipped in, wherein the receiving section (5) is connected to the receiving region (3) of the holder via at least one spring section (7) configured in such a way that the receiving section (5) is movably supported relative to the receiving region (3) and relative to the base region (2) of the holder (1) in the insertion direction of the conduit (100) to be fastened,
wherein, to facilitate the insertion of the conduit (100) to be fastened into the receiving section (5) and in particular to facilitate the clipping of the conduit (100) to be fastened in the receiving section (5), the holder (1) further comprises an insertion aid associated with the receiving section (5), which comprises at least one lead-in chamfer connected with the receiving region (3) of the holder (1), extending at least towards the insertion region (6) of the receiving section (5) and provided with a window or recess area (9),
wherein the at least one lead-in chamfer is configured such that the at least one spring section (7) can move at least partially or in regions in the window or recess area (9) of the lead-in chamfer or through the window or recess area (9) of the lead-in chamfer at least during movement of the receiving section (5) relative to the receiving region (3) of the holder (1).

2. The holder (1) according to claim 1,
wherein the window or recess region (9) of the lead-in chamfer is configured such that the lead-in chamfer is divided into a first region (8.1) and a second (8.2) region separated therefrom via the window or recess region (9).

3. The holder (1) according to claim 2,
wherein—when viewed in the longitudinal extension direction of the receiving section (5)—the distance between the first region (8.1) of the lead-in chamfer and the second region (8.2) of the lead-in chamfer separated therefrom via the window or recess region (9) is greater than a width of the spring section (7), which is preferably embodied in particular as a strip-shaped wall section.

4. The holder (1) according to claim 3,
wherein the first and second regions (8.1, 8.2) of the lead-in chamfer are preferably respectively embodied as a strip or finger-shaped element having a first end region, via which the strip or finger-shaped element is preferably integrally connected to the receiving region (3) of the holder (1), and having an opposite second, free end region.

5. The holder (1) according to claim 1,
wherein the lead-in chamfer is embodied as spring-mounted at least in the insertion direction, preferably in that—when viewed in cross-section—the lead-in chamfer has a reduced wall thickness in the area by which the lead-in chamfer is integrally connected to the receiving region (3) of the holder (1).

6. The holder (1) according to claim 1,
wherein the insertion aid associated with the receiving section (5) comprises at least one lead-in chamfer with a corresponding window or recess area (9) on both sides of the insertion region (6).

7. The holder (1) according to claim 6,
wherein, when viewed in the cross section of the holder (1), a distance between the free end areas of the lead-in chamfers provided on both sides of the insertion region (6) is smaller than a distance between the regions of the receiving section (5) forming the insertion region (6) of the receiving section (5) with a cross section wall which is at least substantially shaped as a circle segment or U-shaped.

8. The holder (1) according to claim 1,
wherein a free end region of the at least one lead-in chamfer does not extend into the insertion region (6) of the receiving section (5); or
wherein a free end region of the at least one lead-in chamfer extends at least into the insertion region (6) of the receiving section (5) and preferably further serves as a holder for a conduit (100) received in the recess of the receiving section (5).

9. The holder (1) according to claim 1,
wherein the at least one spring section (7) is embodied as an in particular strip-shaped wall section having a first end region via which the spring section (7) is preferably integrally connected to the receiving region (3) of the holder (1) and having an opposite second end region via which the spring section (7) is preferably integrally connected to the receiving section (5).

10. The holder (1) according to claim 9,
wherein, when viewed in the cross-sectional direction of the spring section (7), a wall thickness of the in particular strip-shaped wall section is less at least in some regions than an in particular average wall thickness of the cross section wall, shaped at least substantially as a circle segment or U-shaped, of the receiving section (5).

11. The holder (1) according to claim 1,
wherein—when viewed in the cross-sectional direction of the spring section (7)—the spring section (7) has a shape that is at least partially twisted or twisted in certain regions, and in particular an at least substantially S shape.

12. The holder (1) according to claim 1,
wherein the at least one receiving section (5) of the insertion region (6) with a cross section wall shaped at least substantially as a circle segment or U-shaped is preferably integrally connected on both sides to the receiving region (3) of the holder (1) via at least one spring section (7).

13. The holder (1) according to claim 1,
wherein a region in which the spring section (7) is preferably integrally connected to the receiving region (3) of the holder (1) is disposed offset towards the base region (2) of the holder (1) to a region in which the lead-in chamfer is preferably integrally connected to the receiving region (3) of the holder (1).

14. The holder (1) according to claim 1,
wherein the receiving region (3) comprises at least two wall regions (10) extending away from the base region (2) and preferably at least substantially parallel to each other, between which a receiving section (5) with a cross section wall shaped at least substantially as a circle segment or U-shaped is disposed at least partially or in regions.

15. The holder (1) according to claim 14,
wherein a first spring section (7) is connected to a first of the at least two wall regions (10) of the receiving region (3) and to the receiving section (5) on the one hand, and wherein a second spring section (7) is on the one hand connected to a second of the at least two wall regions (10) of the receiving region (3), or on the other hand integrally connected to the receiving section (5).

16. The holder (1) according to claim 14,
wherein a first lead-in chamfer of the insertion aid associated with the receiving section (5) is connected to a first of the at least two wall regions (10) of the receiving region (3), and wherein a second lead-in chamfer of the insertion aid associated with the receiving section (5) is in each case preferably integrally connected to a second of the at least two wall regions (10) of the receiving region (3).

17. The holder (1) according to claim 1,
wherein at least two and preferably three receiving sections (5) disposed adjacent to each other are associated with the receiving region (3) such that, when the respective conduits (100) to be attached are inserted into the respective receiving sections (5), the respective insertion directions are at least substantially parallel.

18. The holder (1) according to claim 1,
wherein the receiving section (5) comprises at least one reinforcing rib (13) extending at least substantially in the longitudinal extension direction of the receiving section (5), preferably on an outer shell surface of the wall of the receiving section (5), with a cross section wall shaped at least substantially as a circle segment or U-shaped.

19. The holder (1) according to claim 1,
wherein the base region (2) on the side facing away from the receiving region (3) comprises an at least substantially flat abutment surface (12).

20. The holder (1) according to claim 1,
wherein the holder (1) comprises a sleeve-like shoulder (11) containing the bolt receiving opening (4), wherein at least a region of the sleeve-like shoulder (11) extends into the receiving region (3) of the holder (1).
